(19) United States
(12) Patent Application Publication
(10) Pub. No.: US 2025/0217647 A1
(43) Pub. Date: Jul. 3, 2025

(54) MACHINE LEARNING APPARATUS, MACHINE LEARNING METHOD, AND NON-TRANSITORY COMPUTER-READABLE STORAGE MEDIUM STORING MACHINE LEARNING PROGRAM FOR CONTINUALLY LEARNING CLASSIFICATION TASK THAT USES DATA OF NOVEL CLASS WITH SMALLER NUMBER OF SAMPLES THAN DATA OF BASE CLASS

(71) Applicant: JVCKENWOOD Corporation, Yokohama-shi (JP)

(72) Inventor: Maki TAKAMI, Yokohama-shi (JP)

(21) Appl. No.: 19/084,079

(22) Filed: Mar. 19, 2025

Related U.S. Application Data
(63) Continuation of application No. PCT/JP2023/018056, filed on May 15, 2023.

(30) Foreign Application Priority Data
Sep. 20, 2022 (JP) 2022-149149

(51) Int. Cl. G06N 3/08; G06F 18/2413

(52) U.S. Cl. CPC G06N 3/08; G06F 18/2413

(57) ABSTRACT

In a machine learning apparatus of the present invention, a neural network outputs a base class classification and a novel class classification. A loss calculation part calculates losses in the base class and novel class classification. An updating part updates a weight based on the losses in the base class and novel class classification. The updating part updates the weight by providing the weight with a regularization term and a sum of the losses.

### CROSS-REFERENCE TO RELATED APPLICATION

This application is a continuation of application No. PCT/JP2023/018056, and claims the benefit of priority from the prior Japanese Patent Application No. 2022-149149, filed on Sep. 20, 2022, the entire contents of which is incorporated herein by reference.

### BACKGROUND

### 1. Field of the Invention

The present invention relates to machine learning technologies.

### 2. Description of the Related Art

Human beings can learn new knowledge through experiences over a long period of time and can maintain old knowledge without forgetting it. Meanwhile, the knowledge of a neutral network depends on the dataset used in learning. To adapt to a change in data distribution, it is necessary to re-learn parameters of the neural network in response to the entirety of the new dataset in which the data distribution has changed.

A more efficient and practical method available is incremental learning or continual learning in which new tasks are learned, reusing the knowledge already acquired. In particular, continual learning in a classification task is a method that allows migration from a state in which classification into base classes (classes learned in the past) is enabled to a state in which new classes (novel classes) can be learned for classification.

Meanwhile, there is a phenomenon in deep learning called catastrophic forgetting in which the knowledge acquired in the past is considerably lost, and the ability for tasks is considerably reduced. This presents a problem in continual learning in particular. In continual learning in a classification task, the biggest challenge is to suppress catastrophic forgetting and maintain the performance for base class classification while at the same time acquiring the performance for novel class classification.

On the other hand, new tasks often have only a limited number of sample data items available. Therefore, few-shot learning has been proposed as a method to efficiently learn from a small amount of training data. In few-shot learning, instead of re-learning previously learned parameters, a novel task is learned by using a small number of additional parameters. Normally, several thousands or more samples are necessary for learning. In few-shot learning, however, a task is learned by using a small number of samples (e.g., several samples) per class.

Further, class incremental learning (CIL) has been proposed to additionally train a model already trained on a basic (base) class, thereby enabling classification into a new class (novel class). In CIL, tasks are continually added to a model trained for classification, and new tasks require classification performance for novel classes and past classes. Normally, training data for new tasks is big data.

A method called incremental few-shot learning (IFSL) has been proposed, which combines continual learning, in which a novel class is learned in the presence of the result of learning the base class, and few-shot learning, in which a novel class is learned with fewer examples per class as compared to the base class (Non-Patent Literature 1). In incremental few-shot learning, the base class can be learned from a large-scale dataset, while the novel class can be learned from a small number of sample data items. IFSL is an incremental learning scenario for classification similar to CIL but significantly differs in that the number of samples in the training data of a novel class is small (small data).

SaB (Split-and-Bridge) has been proposed (see, for example, Non-Patent Literature 2) as one method for continual learning in classification learning. SaB realizes high adaptability to new classes and suppression of the forgetting of past knowledge, while restraining the growth of the network scale. The SaB consists of a split phase in which the network is divided into partitions for past knowledge and new knowledge in an incremental task to learn the knowledge, and of a bridge phase in which the network portions are subsequently recombined and trained. In the split phase, the lower layer of the network is shared between past knowledge and new knowledge, and the upper layer of the network is divided and allocated to past knowledge and new knowledge, respectively to enable separate acquisition of past knowledge and new knowledge in the local space (learning is performed concurrently). In the bridge phase, the integrated knowledge of past and new classes is learned by combining the divided network partitions.
[Non-Patent Literature 1] Zhang, C., Song, N., Lin, G., Zheng, Y., Pan, P., & Xu, Y. (2021). Few-shot incremental learning with continually evolved classifiers. In Proceedings of the IEEE/CVF Conference on Computer Vision and Pattern Recognition (pp. 12455-12464)
[Non-Patent Literature 2] Jong-Yeong Kim, Dong-Wan Choi. (2021). “Split-and-Bridge: Adaptable Class Incremental Learning within a Single Neural Network.” In Proceedings of the AAAI Conference on Artificial Intelligence (pp. 8137-8145).

SaB uses the weight of the lower layer of the network commonly in past knowledge and new knowledge so that the weight of the lower layer of the network is updated by learning new knowledge. That is, the data of a novel class also affects the performance for past knowledge. In IFSL, on the other hand, learning in an incremental task is performed with a small number of samples, but information may be biased as a whole because the impact of a single sample is intensely exhibited. In the case IFSL is applied to an architecture such as SaB, in which a part of the network is shared between past knowledge and new knowledge to update the network weight as a whole, there is a very high possibility that past knowledge will be forgotten by learning with a small amount of data.

### SUMMARY

A machine learning apparatus according to an embodiment is a machine learning apparatus that continually learns a classification task that uses data of a novel class with a smaller number of samples as compared to data of a base class, the machine learning apparatus including: a pre-trained neural network, including: a neural network lower layer part that receives the data of a base class and the data of a novel class and outputs a value; and a neural network upper layer part that is provided on an output side with respect to the neural network lower layer part and that includes i) a base class classification output part that receives an output value of the neural network lower layer part based on the data of a base class and the data of a novel class and that outputs a base class classification which is a classification based on the data of a base class and the data of a novel class and ii) a novel class classification output part that receives an output value of the neural network lower layer part based on the data of a novel class and that outputs a novel class classification which is a classification based on the data of a novel class, the machine learning apparatus further including: a loss calculation part that calculates a loss in the base class classification and a loss in the novel class classification based on the base class classification and the novel class classification; and an updating part that updates a weight of the neural network based on the loss in the base class classification and the loss in the novel class classification, wherein the updating part updates a weight of the base class classification output part and a weight of the novel class classification output part based on a loss derived from summing the loss in the base class classification and the loss in the novel class classification in a current classification task, wherein the loss calculation part calculates a regularization term based on a weight of the neural network lower layer part updated in the classification task performed prior to the current classification task and a weight of the neural network lower layer part updated in the current classification task, and wherein the updating part updates the weight of the neural network lower layer part by providing the weight of the neural network lower layer part with the regularization term and the loss derived from summing.

A machine learning apparatus according to another embodiment is a machine learning apparatus that continually learns a classification task that uses data of a novel class with a smaller number of samples as compared to data of a base class, the machine learning apparatus including: a neural network that receives the data of a base class and the data of a novel class and outputs a classification, wherein the neural network includes: a neural network lower layer part that receives the data of a base class and the data of a novel class and outputs a value; and a neural network upper layer part that is provided on an output side with respect to the neural network lower layer part, wherein the neural network uses a weight of a further neural network updated based on the same data of a base class and the same data of a novel class received by the neural network, wherein the further neural network includes a further neural network lower layer part that receives the data of a base class and the data of a novel class and outputs a value and a further neural network upper layer that is provided on an output side with respect to the further neural network lower layer part, wherein the further neural network upper layer part includes i) a base class classification output part that receives an output value of the further neural network lower layer part based on the data of a base class and the data of a novel class and that outputs a base class classification which is a classification based on the data of a base class and the data of a novel class and ii) a novel class classification output part that receives an output value of the further neural network lower layer part based on the data of a novel class and that outputs a novel class classification which is a classification based on the data of a novel class, wherein the weight of the neural network lower layer part, a weight of the base class classification output part, and a weight of the novel class classification output part are updated based on a loss derived from summing the loss in the base class classification and the loss in the novel class classification in the current classification task, and wherein the neural network upper layer part corresponds to a configuration derived from integrating the base class classification output part and the novel class classification output part of the further neural network upper layer part and uses a weight derived from integrating the weight of the base class classification output part and the weight of the novel class classification output part, the machine learning apparatus further including: a loss calculation part that calculates a loss in classification based on the classification; and an updating part that updates a weight of the neural network based on the loss in classification, wherein the loss calculation unit calculates a regularization term based on a weight of the further neural network lower layer part updated in the current classification task and a weight of the neural network lower layer part updated in the current classification task, and wherein the updating part updates the weight of the neural network upper layer part based on the loss in classification and updates the weight of the neural network lower layer part by providing the weight of the neural network lower layer part with the regularization term and the loss in classification.

A machine learning method according to another embodiment is a machine learning method that continually learns a classification task that uses data of a novel class with a smaller number of samples as compared to data of a base class, the machine learning method including: inputting the data of a base class and the data of a novel class to a neural network, wherein the neural network is a pre-trained neural network, including: a neural network lower layer part that receives the data of a base class and the data of a novel class and outputs a value; and a neural network upper layer part that is provided on an output side with respect to the neural network lower layer part and that includes i) a base class classification output part that receives an output value of the neural network lower layer part based on the data of a base class and the data of a novel class and that outputs a base class classification which is a classification based on the data of a base class and the data of a novel class and ii) a novel class classification output part that receives an output value of the neural network lower layer part based on the data of a novel class and that outputs a novel class classification which is a classification based on the data of a novel class, the machine learning method further including: outputting, from the neural network, the base class classification and the novel class classification according to an input of the data of a base class and the data of a novel class; calculating a loss in the base class classification and a loss in the novel class classification based on the base class classification and the novel class classification; and updating a weight of the neural network based on the loss in the base class classification and the loss in the novel class classification, wherein the updating includes: updating a weight of the base class classification output part and a weight of the novel class classification output part based on a loss derived from summing the loss in the base class classification and the loss in the novel class classification in a current classification task; and updating a weight of the neural network lower layer part by providing the weight of the neural network lower layer part with i) a regularization term calculated based on a weight of the neural network lower layer part updated in the classification task performed prior to the current classification task and a weight of the neural network lower layer part updated in the current classification task and ii) the loss derived from summing.

A non-transitory computer-readable storage medium storing a machine learning program according to another embodiment is a machine learning program that continually learns a classification task that uses data of a novel class with a smaller number of samples as compared to data of a base class, the machine learning program including computer-implemented modules including: a module that inputs the data of a base class and the data of a novel class to a neural network, wherein the neural network is a pre-trained neural network, including: a neural network lower layer part that receives the data of a base class and the data of a novel class and outputs a value; and a neural network upper layer part that is provided on an output side with respect to the neural network lower layer part and that includes i) a base class classification output part that receives an output value of the neural network lower layer part based on the data of a base class and the data of a novel class and that outputs a base class classification which is a classification based on the data of a base class and the data of a novel class and ii) a novel class classification output part that receives an output value of the neural network lower layer part based on the data of a novel class and that outputs a novel class classification which is a classification based on the data of a novel class, the computer-implemented modules further including: a module that outputs, from the neural network, the base class classification and the novel class classification according to an input of the data of a base class and the data of a novel class; a module that calculates a loss in the base class classification and a loss in the novel class classification based on the base class classification and the novel class classification; and a module that updates a weight of the neural network based on the loss in the base class classification and the loss in the novel class classification, wherein the that module to update the weight: updates a weight of the base class classification output part and a weight of the novel class classification output part based on a loss derived from summing the loss in the base class classification and the loss in the novel class classification in a current classification task; and updates a weight of the neural network lower layer part by providing the weight of the neural network lower layer part with i) a regularization term calculated based on a weight of the neural network lower layer part updated in the classification task performed prior to the current classification task and a weight of the neural network lower layer part updated in the current classification task and ii) the loss derived from summing.

Optional combinations of the aforementioned constituting elements, and implementations of the embodiments in the form of methods, apparatuses, systems, recording mediums, and computer programs may also be practiced as modes of the embodiments.

### BRIEF DESCRIPTION OF THE DRAWING

Embodiments will now be described, by way of example only, with reference to the accompanying drawings which are meant to be exemplary, not limiting, and wherein like elements are numbered alike in several Figures, in which:

FIG. 1 shows a configuration of a pre-training module;

FIG. 2 shows an ordinary configuration of an NN;

FIG. 3 is a diagram illustrating a configuration of the NN used in the split phase of SaB;

FIG. 4 is a functional block diagram for explaining a configuration of a related-art machine learning apparatus used in the split phase of SaB;

FIG. 5 is a functional block diagram for explaining a configuration of the related-art machine learning apparatus used in the bridge phase of SaB;

FIG. 6 is a functional block diagram for explaining a configuration of the machine learning apparatus of the first embodiment used in the split phase of SaB;

FIG. 7 is a functional block diagram for explaining a configuration of the machine learning apparatus of the first embodiment used in the bridge phase of SaB;

FIG. 8 is a functional block diagram for explaining a configuration of a machine learning apparatus of the second embodiment used in the split phase of SaB; and

FIG. 9 is a functional block diagram for explaining a configuration of the machine learning apparatus of the second embodiment used in the bridge phase of SaB.

### DETAILED DESCRIPTION

The invention will now be described by reference to the preferred embodiments. This does not intend to limit the scope of the present invention, but to exemplify the invention.

First, an overview of SaB, which is a related art, will be described. In SaB, a common neural network (hereinafter, sometimes referred to as “NN”) model is used to perform classification.

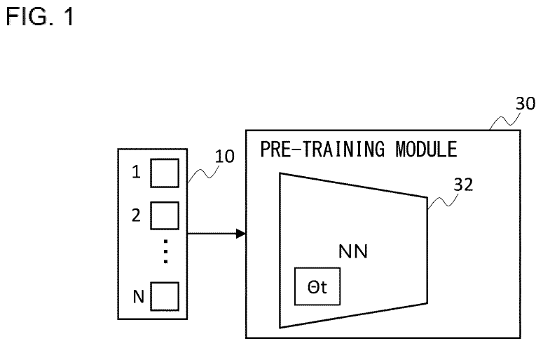

First, in a basic task of incremental learning, the NN is pre-trained for base class classification by using big data. FIG. 1 shows a configuration of a pre-training module 30. The pre-training module 30 includes an NN32 and a base class classification weight Θₜ of the NN32.

A base class dataset 10 includes N samples. One example of a sample is an image, but the sample is not limited thereto. The NN32 is a neural network pre-trained on the base class dataset 10. The weight of the NN32 is Θₜ.

In an incremental task in SaB incremental learning, learning is performed in the split phase based on a trained weight, and the trained weight is further trained in the bridge phase.

The split phase aims to learn i) past knowledge (base class) in a local space for classification into a past class in a past task relative to the current incremental task and ii) new knowledge (novel class) in a local space for classification into a novel class in the current incremental task. In the split phase, therefore, the upper layer part in the NN32 is divided into two partitions including a part that uses a weight θₒ for learning the base class and a part using a weight θₙ for learning the novel class. In the lower layer part of the NN32, a weight θₛ is commonly used for the base class and the novel class. In this case, the base class loss is calculated by using <θₛ, θₒ>. The novel class loss is calculated by using <θₛ, θₙ>. Learning is performed based on a loss derived from summing the losses in the base class and the novel class.

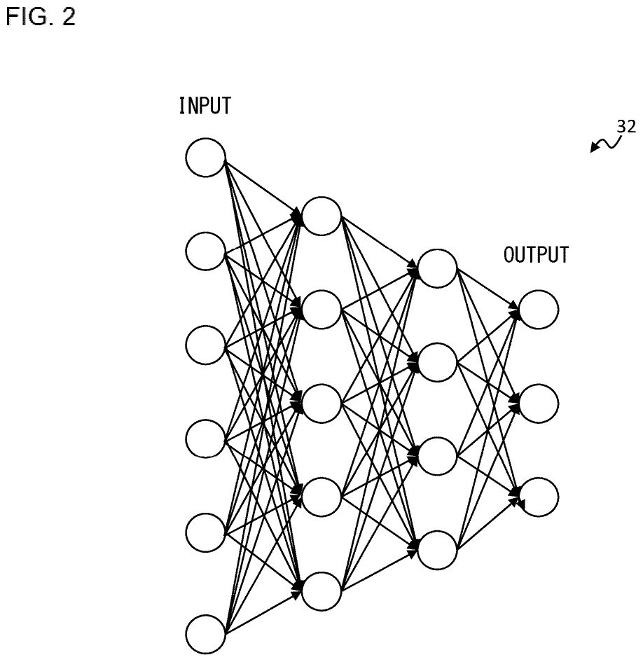

FIG. 2 shows an ordinary configuration of the NN32. In an ordinary NN, as shown in FIG. 2, the nodes between adjacent layers are all connected. An output value is delivered from the node on side of the input layer to the node on the side of the output layer. An ultimate output is output from the output layer. This ultimate output is converted to a probability value by a function such as the softmax function.

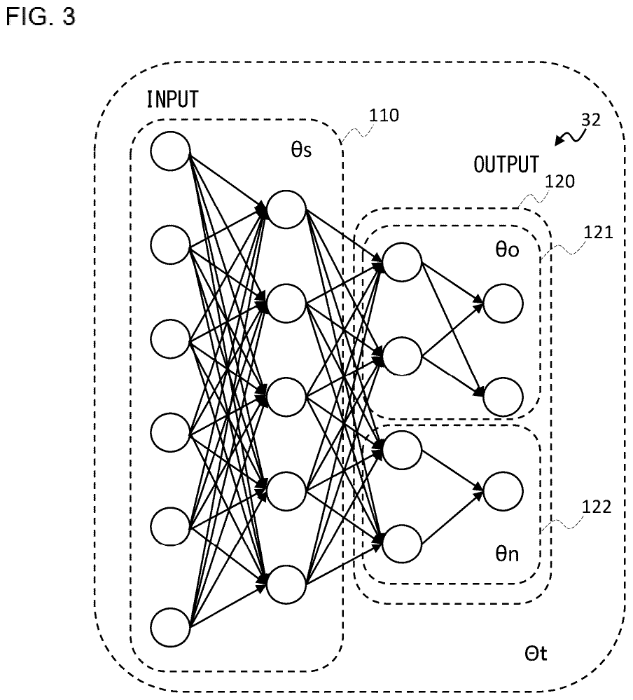

FIG. 3 is a diagram illustrating a configuration of the NN32 used in the split phase of SaB. In SaB, as shown in FIG. 3, an NN lower layer part 110 comprised of one or more layers on the input side and an NN upper layer part 120 comprised of one or more layers on the output side with respect to the NN lower layer part 110 are set in the NN 32. The weight of the NN32 as a whole is Θₜ. Of Θₜ, the weight θₛ is used in the NN lower layer part 110. In the NN upper layer part 120, the base class classification weight θₒ and the novel class classification weight θₙ are used in the two partitions. The NN upper layer part 120 includes a base class classification output part 121 that uses base class classification weight θₒ and a novel class classification output part 122 that uses the novel class classification weight θₙ. Prior to the split phase, a preprocess for sparsification of the weights to be disconnected in the split phase is performed. The nodes in the base class classification output part 121 and the nodes in the novel class classification output part 122 are not coupled. Therefore, there is no propagation between these nodes. For example, the method described in Non-Patent Literature 2 is used as the method for setting the NN lower layer part 110 with the weight θₛ, the base class classification output part 121 with the weight θ, and the novel class classification output part 122 of the weight θₙ based on the pre-trained NN32 with the weight Qt.

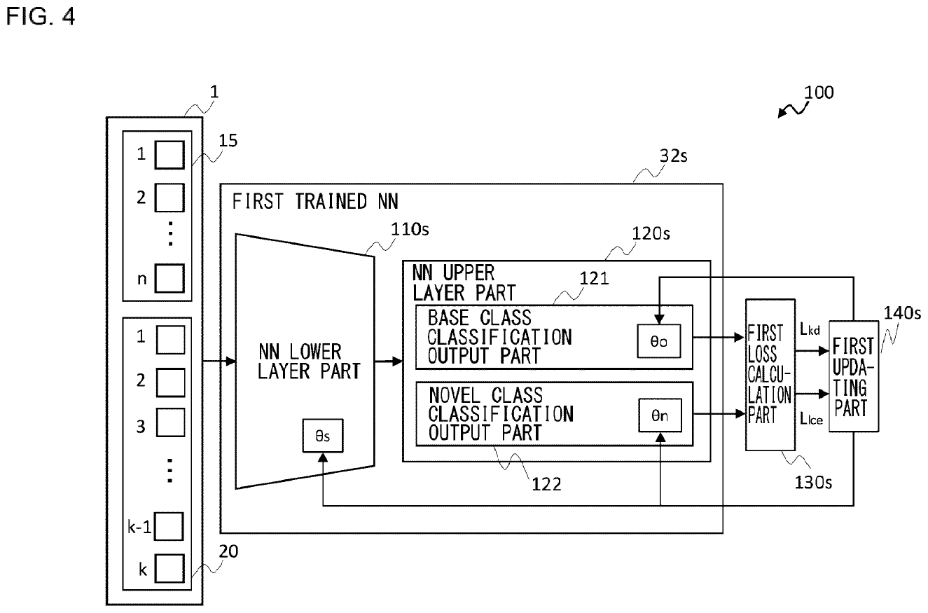

FIG. 4 is a functional block diagram for explaining a configuration of a related-art machine learning apparatus 100 used in the split phase of SaB. The machine learning apparatus 100 of FIG. 4 is about to learn an incremental task. The dataset 1 includes rehearsal data 15 of a base class and a dataset 20 of a novel class. The rehearsal data 15 of a base class represents a part of the dataset 10 of a base class and includes n samples (N>n). The dataset 20 of a new class includes k samples. One example of a sample is an image, but the sample is not limited thereto.

The related-art machine learning apparatus 100 includes a first trained NN32s pre-trained on the base class, a first loss calculation part 130s, and a first updating part 140s. The first trained NN 32s includes an NN lower layer part 110s and an NN upper layer part 120s.

The NN lower layer part 110s receives data of a base class and data of a novel class. The NN lower layer part 110s outputs values by using the weight θₛ in response to both the base class data and the novel class data.

In SaB, as described above, the NN upper layer part 120s includes the base class classification output part 121 that uses the weight θₒ and the novel class classification output part 122 that uses the weight θn. The base class classification output part 121 receives the output value of the NN lower layer part 110s based on the data of a base class and a novel class. The base class classification output part 121 outputs a classification (hereinafter referred to as a base class classification) based on the data of a base class and a novel class by using the weight θₒ. The novel class classification output part 122 receives the output value of the NN lower layer part 110s based on the data of a novel class. The novel class classification output part 122 outputs a classification (hereinafter referred to as a novel class classification) based on the data of a novel class by using a weight θn.

The first loss calculation part 130s receives the base class classification and the novel class classification from the NN upper layer part 120s. The first loss calculation part 130s calculates a knowledge distillation loss Lkd based on the base class classification. The first loss calculation part 130s calculates a cross-entropy loss Llce based on the novel class classification.

The first updating part 140s receives the knowledge distillation loss Lkd and the cross-entropy loss Llce from the first loss calculation part 130s. The first updating part 140s updates the weights θₛ, θₒ and θn based on the loss derived from summing the knowledge distillation loss Lkd and the cross-entropy loss Llce. In updating the weights θₛ, θₒ and θn, the weights θₛ, θₒ and θn of the NN lower layer part 110s are respectively updated so as to reduce the sum of the knowledge distillation loss Lkd and the cross-entropy loss Llce. For example, the method described in Non-Patent Literature 2 is used as the method for calculating the loss in classification in the first loss calculation part 130s and the updating method in the first updating part 140s.

A series of processes of the split phase described above are repeatedly executed according to the number of one or more epochs defined as hyperparameters.

The bridge phase aims to learn integrated knowledge that classifies all past and novel classes in the current incremental task. The bridge phase is adapted to learn integrated knowledge with the weights θₛ, θₒ, and θn updated in the split phase. In the bridge phase, the nodes in the base class classification output part 121 and the novel class classification output part 122 of FIG. 3 that were not connected are connected, and learning is performed in a normal NN state as shown in FIG. 2.

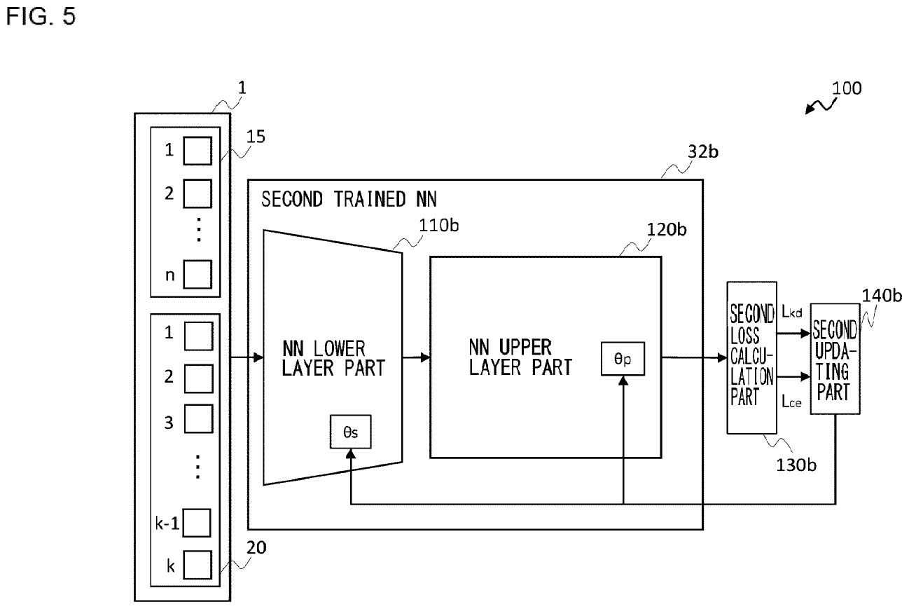

FIG. 5 is a functional block diagram for explaining a configuration of the related-art machine learning apparatus 100 used in the bridge phase of SaB. A duplicate description of the configuration of the related-art machine learning apparatus 100 used in the split phase of SaB will be omitted, and only the differences will be highlighted.

The related-art machine learning apparatus 100 includes a second trained NN32b trained in the split phase, a second loss calculation part 130b, and a second updating part 140b. In the bridge phase, the second trained NN32b uses, as initial values, the weights of the classifier trained in the first trained NN32s, i.e., the weights θₛ, θₒ, and θn updated by the first updating part 140s in the split phase. The second trained NN 32b includes an NN lower layer part 110b that uses the weight θₛ updated in the split phase, and an NN upper layer part 120b that uses a weight θₚ derived from integrating the weights θₒ and θn updated in the split phase.

The second trained NN32b receives data of a base class and data of a novel class. The second trained NN32b outputs a classification (hereinafter referred to as an integrated classification) based on the data of a base class and the data of a novel class by using the weights θₛ and θₚ. The data input to the second trained NN32b is the same data as used in the split phase. The second trained NN32b has the same number of layers and nodes as the first trained NN32s. The second trained NN32b corresponds to a configuration in which the nodes between adjacent layers are all connected in the base class classification output part 121 and the novel class classification output part 122 of the first trained NN32s. The NN lower layer part 110b of the second trained NN32b has the same number of layers and nodes as the NN lower layer part 110s of the first trained NN32s. The NN upper layer part 120b of the second trained NN32b has the same number of layers and nodes as the NN upper layer part 120s of the first trained NN32s. The NN upper layer part 120b of the second trained NN32b corresponds to a configuration in which the nodes between adjacent layers are all connected in the base class classification output part 121 and the novel class classification output part 122 of the first trained NN32s. Therefore, the NN upper layer part 120b of the second trained NN32b corresponds to a configuration in which the base class classification output part 121 and the novel class classification output part 122 of the NN upper layer part 120s of the first trained NN32s are integrated.

The second loss calculation part 130b receives an integrated classification from the second trained NN32b. The second loss calculation part 130b calculates the knowledge distillation loss Lkd and the cross-entropy loss Lce respectively based on the integrated classification and calculates the sum of the knowledge distillation loss Lkd and the cross-entropy loss Lce The as the loss in classification. The sum of the knowledge distillation losses Lkd and the cross-entropy losses Lce in the bridge phase is an example of the loss in classification.

The second updating part 140b updates the weights θₛ and θₚ of the second trained NN32b based on the loss in classification. For example, the second updating part 140b receives the loss in classification from the second loss calculation part 130b and updates the weights θₛ and θₚ based on the loss in classification. The weights θₛ and θₚ of the second trained NN32b are updated respectively so as to reduce the loss in classification.

A series of processes of the bridge phase are repeatedly executed according to the number of one or more epochs defined as hyperparameters.

Since the related-art SaB assumes CIL, big data, i.e., a large number of samples, are used for the novel class in the incremental task.

IFSL uses training data (small data) with a small number of novel tasks. Therefore, while proper learning is more difficult in IFSL than in CIL, IFSL is a more realistic scenario because it does not require a large amount of data to be collected. In view of this importance of the IFSL scenario, application of IFSL to SaB described above will be considered in this invention. Considering the conditions of the CIL and IFSL scenarios, it is possible to apply IFSL to SaB.

In SaB, however, the weight θₛ of the NN lower layer part 110 is commonly used in the partition for learning the base class and the partition for learning the novel class so that the weight θₛ is updated by learning the novel class. That is, the data of a novel class also affects the performance of the NN trained based on the base class.

In IFSL, on the other hand, learning in an incremental task is performed with a small number of samples. However, information is biased as a whole because of the large impact of a single sample. When IFSL is applied to SaB, therefore, the weight θₛ is updated based on a small amount of data so that the impact of a single sample is intensely exhibited in the updated weight θₛ. As a result, it is highly likely that the classification performance for the base class and the novel class will be reduced.

We have noticed that when the weight θₛ of the NN lower layer part 110, which is commonly used in the partition for past knowledge and the partition for new knowledge, changes significantly based on a small amount of data, catastrophic forgetting occurs more easily than in the case where the weights θₒ and θn of the NN upper layer part 120 change significantly based on a small amount of data so that the classification accuracy of the NN is easily reduced significantly. That is, the present invention constrains an update to the weight θₛ of the NN lower layer part 110 commonly used in the partition for past knowledge and the partition for new knowledge. Embodiments of the present invention will be described hereinafter.

### First Embodiment

A description will now be given of the first embodiment of the present invention. In the drawings and description of the first embodiment, the same or equivalent constituting elements as those of the related-art configuration are denoted by the same reference numerals. Duplicative explanations are omitted appropriately and features different from those of the related-art configuration will be highlighted.

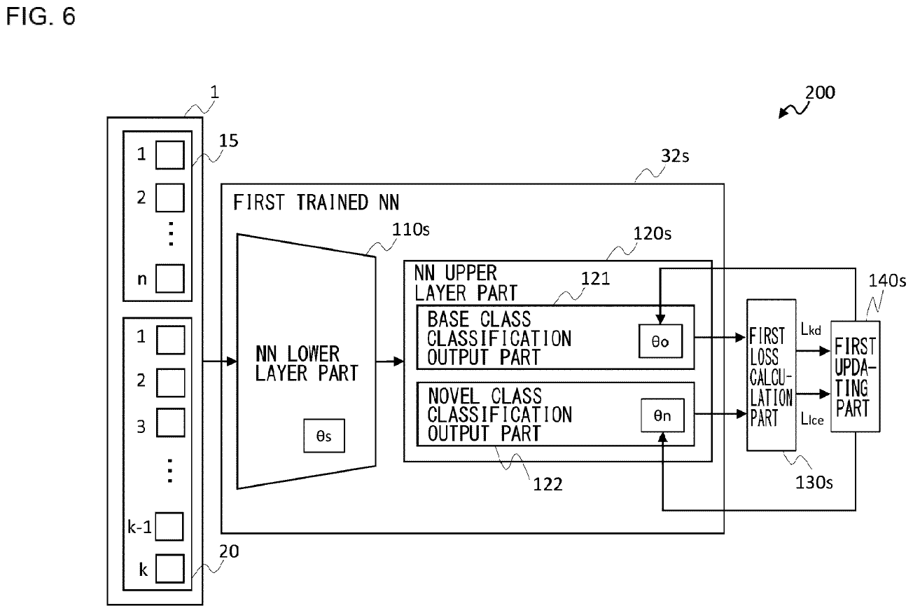

FIG. 6 is a functional block diagram for explaining a configuration of a machine learning apparatus 200 of the first embodiment used in the split phase of SaB. The machine learning apparatus 200 of the first embodiment includes a first trained NN32s, a first loss calculation part 130s, and a first updating part 140s. The first trained NN 32s includes an NN lower layer part 110s and an NN upper layer part 120s. The first trained NN32s uses the weight Θₜ of the pretrained basic class classifier. Of the weights Θₜ, the weight θₛ is used in the NN lower layer part 110, the base class classification weight θₒ is used in the base class classification output part 121 of the NN upper layer part 120, and the novel class classification weight θₙ is used in the novel class classification output part of the NN upper layer part 120.

The machine learning apparatus 200 of the first embodiment continually learns a classification task that uses the data of a novel class with a smaller number of samples than the data of a base class in the split phase. The dataset 20 of a novel class contains a smaller number of samples than the dataset 10 of a base class. The same applies to the bridge phase described below.

The first updating part 140s receives the knowledge distillation loss Lkd and the cross-entropy loss Llce from the first loss calculation part 130s. The first updating part 140s updates the weights θₒ and θn of the first trained NN32s based on the loss derived from summing the knowledge distillation loss Lkd and the cross-entropy loss Llce. In this update, the weight θₒ of the base class classification output part 121 and the weight θn of the novel class classification output part 122 are updated so as to reduce the sum of the knowledge distillation loss Lkd and the cross-entropy loss Llce. In this case, the weight θₛ is fixed as a constraint on an update to the weight θₛ of the NN lower layer part 110 in the machine learning apparatus 200 of the first embodiment. Therefore, while the weight θₒ of the base class classification output part 121 and the weight θₙ of the novel class classification output part 122 are updated, the weight θₛ of the NN lower layer part 110s remains fixed (the weight θₛ is not updated). That is, the first updating part 140s updates the weight θₒ of the base class classification output part 121 and the weight θn of the novel class classification output part 122 based on the loss derived from summing the loss in the base class classification and the loss in the novel class classification, while fixing the weight θₛ of the NN lower layer part 110s.

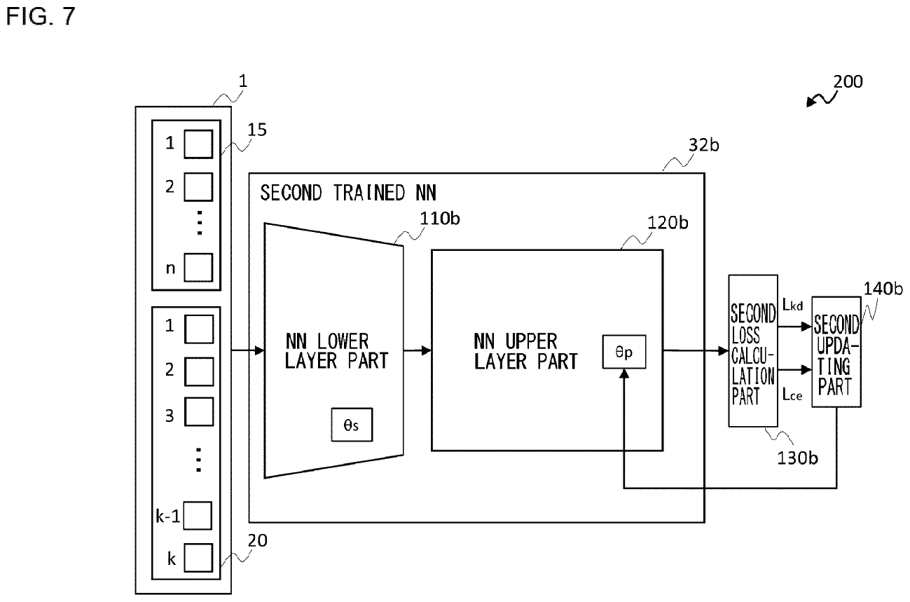

FIG. 7 is a functional block diagram for explaining a configuration of the machine learning apparatus 200 of the first embodiment used in the bridge phase of SaB. The machine learning apparatus 200 of the first embodiment includes the second trained NN32b, the second loss calculation part 130b, and the second updating part 140b. The second trained NN32b includes the NN lower layer part 110b and the NN upper layer part 120b. The NN lower layer part 110b uses the weight θₛ of the NN lower layer part 110s of the first trained NN32s updated in the split phase. The NN upper layer part 120b uses the weight θₚ derived from integrating the weights θₒ and θn of the NN upper layer part 120s of the first trained NN32s updated in the split phase. The first trained NN32s in the bridge phase is an example of a further neural network.

In the machine learning apparatus 200 of the first embodiment, the weight θₛ is fixed as a constraint on an update to the weight θₛ of the NN lower layer part 110b of the second trained NN32b, whereupon integrated knowledge is learned in the second trained NN32b. Therefore, while the weight θₚ of the NN upper layer part 120b of the second trained NN32b is updated, the weight θₛ of the NN lower layer part 110b of the second trained NN32b remains fixed (the weight θₛ is not updated). That is, the second updating part 140b updates the weight θₚ of the NN upper layer part 120b based on the loss in classification which is the sum of the knowledge distillation loss Lkd and the cross-entropy loss Lce, while fixing the weight θ s of the NN lower layer part 110b.

In the first embodiment, the weight θₛ is fixed. According to this configuration, it is possible to suppress the impact of a single sample in a small amount of data on the NN. As a result, it is possible to acquire new knowledge while suppressing fatal forgetting.

In the first embodiment, the knowledge distillation loss Lkd and the cross-entropy loss Lce, Llce are calculated, but the embodiment is not limited thereto, and the loss in classification may be calculated by other methods. The same applies to the second embodiment below.

In the first embodiment, an example in which the weight θₛ is fixed in both the split phase and the bridge phase is shown, but, alternatively, the weight θₛ may be fixed in at least one of the split phase or the bridge phase.

### Second Embodiment

Hereinafter, a second embodiment of the present invention will be described. In the drawings and description of the second embodiment, the same or equivalent constituting elements as those of the first embodiment are denoted by the same reference numerals. Duplicative explanations from the first embodiment are omitted as appropriate, and features different from those of the first embodiment will be highlighted.

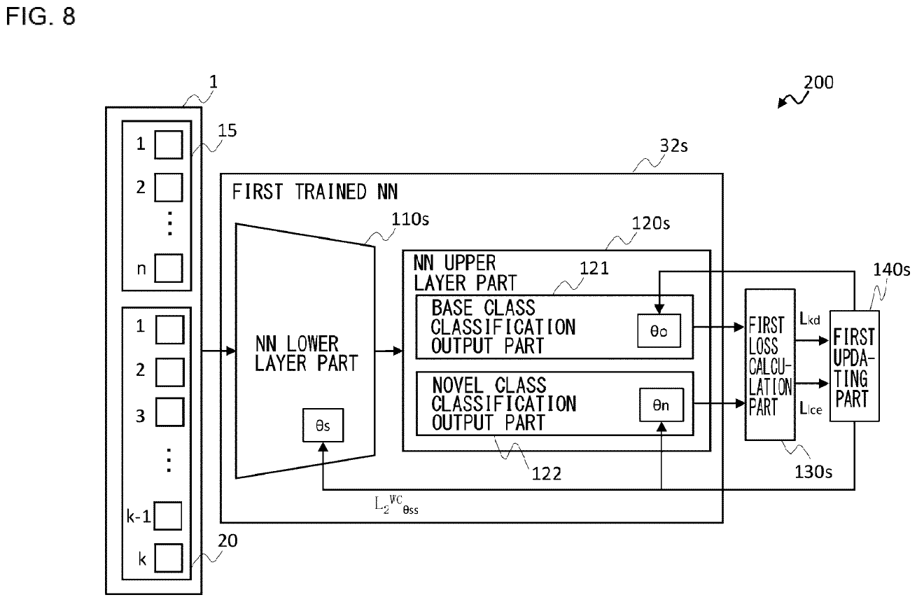

FIG. 8 is a functional block diagram for explaining a configuration of a machine learning apparatus 200 of the second embodiment used in the split phase of SaB. The machine learning apparatus 200 of the second embodiment regularizes the weights as a measure of constraining an update to the weight θₛ.

In the split phase, the first updating part 140s updates the weights θₒ and θn so as to reduce the sum of the knowledge distillation loss Lkd and the cross-entropy loss Llce in the current classification task in continual learning. The first loss calculation part 130s calculates a regularization term L₂^{WC}_{θss} given by the following expression (1) based on the weight θₛ updated in the previous classification task performed prior to the current classification task and the weight θₛ updated in the current classification task. The previous classification task in this case is an incremental task performed in the past by using data different from the data of a novel class used in the current classification task in continual learning. The previous classification task can be, for example, a classification task performed immediately before the current classification task. The first updating part 140s updates the weight θₛ by providing the weight θₛ of the NN lower layer part 110s with a loss derived from summing the calculated regularization term L₂^{WC}_{θss}, the knowledge distillation loss Lkd, and the cross-entropy loss Llce. For example, L2WC weight constraint, etc. can be used as a regularization method.

$${L}_{{2}_{θ ss}}^{WC} = \sum {‖ {θ}_{ss} - {θ}_{sp} ‖}^{2} \qquad ( expression 1 )$$

θₛₚ represents the ultimate weight θₛ of the NN lower layer part 110b that was updated in the bridge phase in the previous classification task. In the case of the first incremental task, there are no previous classification tasks so that the pre-trained weight θₛ is used as θₛₚ. θₛₛ represents the weight θₛ of the NN lower layer part 110s updated in the current classification task. The weight θₛ of the NN lower layer part 110s updated in the immediate previous epoch in the split phase can be used, but the embodiment is not limited thereto. For example, the weight θₛ updated two or more epochs before in the split phase may be used in the current classification task. In the case there are no weights θₛ updated in the previous epoch because the current epoch is the first epoch in the split phase, for example, the weight es is updated by providing only the loss derived from summing the knowledge distillation loss Lkd and the cross-entropy loss Llce and without providing a regularization term.

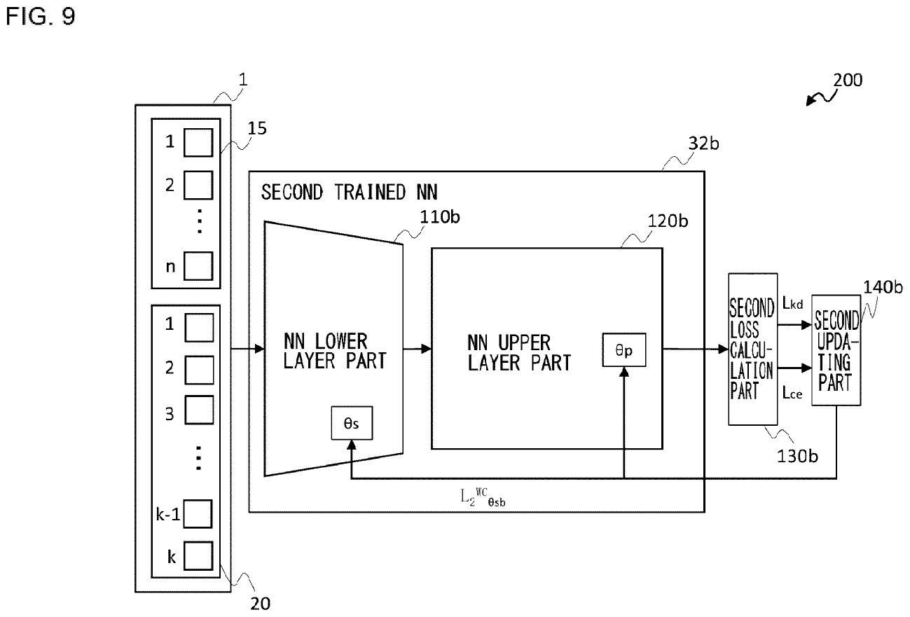

FIG. 9 is a functional block diagram for explaining a configuration of the machine learning apparatus 200 of the second embodiment used in the bridge phase of SaB. In the bridge phase, the second updating part 140b updates the weight θₚ of the NN upper layer part 120b of the second trained NN32b so as to reduce the loss in classification in the current classification task. The second loss calculation part 130b calculates a regularization term L₂^{WC}_{θsb} given by the following expression (2) based on the weight θₛ of the NN lower layer part 110s updated in the split phase in the current classification task and the weight θₛ of the NN lower layer part 110b updated in the bridge phase in the current classification task. The second updating part 140b updates the weight θₛ of the NN lower layer part 110b by providing the weight θₛ of the NN lower layer part 110b with the calculated regularization term L₂^{WC}_{θsb} and the loss in classification. As in the case of the split phase, L₂^{WC} weight constraint, etc. can be used as a regularization method.

$${L}_{{2}_{θ sb}}^{WC} = \sum {‖ {θ}_{sb} - {θ}_{ss} ‖}^{2} \qquad ( expression 2 )$$

θₛₛ represents the ultimate weight θₛ of the NN lower layer part 110s updated in the split phase in the current classification task, and θ_{sb} represents the weight θₛ of the NN lower layer part 110b updated in the current classification task. The weight θₛ of the NN lower layer part 110b updated in the immediate previous epoch in the bridge phase in the current classification task can be used as θ_{sb}, but the embodiment is not limited thereto. For example, the weight θₛ updated two or more epochs before in the bridge phase in the current classification task may be used. In the case there are no weights θₛ updated in the previous epoch because the current epoch is the first epoch in the split phase, for example, the weight θₛ is updated by providing only the loss in classification and without providing a regularization term.

In the second embodiment, it is possible to suppress the impact of a single sample in a small amount of data on the NN by updating the weight θₛ of the NN lower layer part 110b by providing the weight θₛ of the NN lower layer part 110b with the regularization term and the loss in classification. As a result, it is possible to acquire new knowledge while also suppressing catastrophic forgetting.

In the second embodiment, an example of providing the regularization term and the loss in classification to the weight θₛ in both the split phase and the bridge phase is shown, but the embodiment is not limited thereto. For example, the weight θₛ may be provided with the regularization term and the loss in classification in at least one of the split phase or the bridge phase.

As described above, according to the present invention, it is possible to suppress the forgetting of past knowledge in the case IFSL is applied to SaB. As a result, it is possible to improve the classification performance for new classes and maintain the classification performance for past classes.

The above-described various processes in the machine learning apparatus 200 can of course be implemented by apparatuses that use hardware such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Described above is an explanation based on an exemplary embodiment. The embodiment is intended to be illustrative only and it will be understood by those skilled in the art that various modifications to combinations of constituting elements and processes are possible and that such modifications are also within the scope of the present invention.

What is claimed is:

1. A machine learning apparatus that continually learns a classification task that uses data of a novel class with a smaller number of samples as compared to data of a base class, the machine learning apparatus comprising:
a neural network that receives the data of a base class and the data of a novel class and outputs a classification,
wherein the neural network includes:
a neural network lower layer part that receives the data of a base class and the data of a novel class and outputs a value; and
a neural network upper layer part that is provided on an output side with respect to the neural network lower layer part,
wherein the neural network uses a weight of a further neural network updated based on the same data of a base class and the same data of a novel class received by the neural network,
wherein the further neural network includes a further neural network lower layer part that receives the data of a base class and the data of a novel class and outputs a value and a further neural network upper layer that is provided on an output side with respect to the further neural network lower layer part,
wherein the further neural network upper layer part includes i) a base class classification output part that receives an output value of the further neural network lower layer part based on the data of a base class and the data of a novel class and that outputs a base class classification which is a classification based on the data of a base class and the data of a novel class and ii) a novel class classification output part that receives an output value of the further neural network lower layer part based on the data of a novel class and that outputs a novel class classification which is a classification based on the data of a novel class,
wherein the weight of the neural network lower layer part, a weight of the base class classification output part, and a weight of the novel class classification output part are updated based on a loss derived from summing the loss in the base class classification and the loss in the novel class classification in the current classification task, and
wherein the neural network upper layer part corresponds to a configuration derived from integrating the base class classification output part and the novel class classification output part of the further neural network upper layer part and uses a weight derived from integrating the weight of the base class classification output part and the weight of the novel class classification output part,
the machine learning apparatus further comprising:
a loss calculation part that calculates a loss in classification based on the classification; and
an updating part that updates a weight of the neural network based on the loss in classification,
wherein the loss calculation unit calculates a regularization term based on a weight of the further neural network lower layer part updated in the current classification task and a weight of the neural network lower layer part updated in the current classification task, and
wherein the updating part updates the weight of the neural network upper layer part based on the loss in classification and updates the weight of the neural network lower layer part by providing the weight of the neural network lower layer part with the regularization term and the loss in classification.

2. A machine learning method that continually learns a classification task that uses data of a novel class with a smaller number of samples as compared to data of a base class, the machine learning method comprising:
inputting the data of a base class and the data of a novel class to a neural network,
wherein the neural network is a pre-trained neural network, including:
a neural network lower layer part that receives the data of a base class and the data of a novel class and outputs a value; and
a neural network upper layer part that is provided on an output side with respect to the neural network lower layer part and that includes i) a base class classification output part that receives an output value of the neural network lower layer part based on the data of a base class and the data of a novel class and that outputs a base class classification which is a classification based on the data of a base class and the data of a novel class and ii) a novel class classification output part that receives an output value of the neural network lower layer part based on the data of a novel class and that outputs a novel class classification which is a classification based on the data of a novel class,
the machine learning method further comprising:
outputting, from the neural network, the base class classification and the novel class classification according to an input of the data of a base class and the data of a novel class;
calculating a loss in the base class classification and a loss in the novel class classification based on the base class classification and the novel class classification; and
updating a weight of the neural network based on the loss in the base class classification and the loss in the novel class classification,
wherein the updating includes:
updating a weight of the base class classification output part and a weight of the novel class classification output part based on a loss derived from summing the loss in the base class classification and the loss in the novel class classification in a current classification task; and
updating a weight of the neural network lower layer part by providing the weight of the neural network lower layer part with i) a regularization term calculated based on a weight of the neural network lower layer part updated in the classification task performed prior to the current classification task and a weight of the neural network lower layer part updated in the current classification task and ii) the loss derived from summing.

3. A non-transitory computer-readable storage medium storing a machine learning program that continually learns a classification task that uses data of a novel class with a smaller number of samples as compared to data of a base class, the machine learning program comprising computer-implemented modules including:
a module that inputs the data of a base class and the data of a novel class to a neural network,
wherein the neural network is a pre-trained neural network, including:
a neural network lower layer part that receives the data of a base class and the data of a novel class and outputs a value; and
a neural network upper layer part that is provided on an output side with respect to the neural network lower layer part and that includes i) a base class classification output part that receives an output value of the neural network lower layer part based on the data of a base class and the data of a novel class and that outputs a base class classification which is a classification based on the data of a base class and the data of a novel class and ii) a novel class classification output part that receives an output value of the neural network lower layer part based on the data of a novel class and that outputs a novel class classification which is a classification based on the data of a novel class,
the computer-implemented modules further including:
a module that outputs, from the neural network, the base class classification and the novel class classification according to an input of the data of a base class and the data of a novel class;
a module that calculates a loss in the base class classification and a loss in the novel class classification based on the base class classification and the novel class classification; and
a module that updates a weight of the neural network based on the loss in the base class classification and the loss in the novel class classification,
wherein the that module to update the weight:
updates a weight of the base class classification output part and a weight of the novel class classification output part based on a loss derived from summing the loss in the base class classification and the loss in the novel class classification in a current classification task; and
updates a weight of the neural network lower layer part by providing the weight of the neural network lower layer part with i) a regularization term calculated based on a weight of the neural network lower layer part updated in the classification task performed prior to the current classification task and a weight of the neural network lower layer part updated in the current classification task and ii) the loss derived from summing.
